(19) United States
(12) Patent Application Publication
(10) Pub. No.: US 2014/0092753 A1
(43) Pub. Date: Apr. 3, 2014

(54) TRAFFIC-BASED QUALITY OF SERVICE (QOS) MONITORING IN HIGHLY CONSTRAINED NETWORKS

(71) Applicant: CISCO TECHNOLOGY, INC., San Jose, CA (US)

(72) Inventors: Jean-Philippe Vasseur, Saint Martin d'Uriage (FR); Sukrit Dasgupta, Norwood, MA (US); Jonathan W. Hui, Belmont, CA (US)

(73) Assignee: Cisco Technology, Inc., San Jose, CA (US)

(21) Appl. No.: 13/630,909

(22) Filed: Sep. 28, 2012

(51) Int. Cl. H04L 12/26

(52) U.S. Cl. 370/248

(57) ABSTRACT

In one embodiment, one or more monitoring nodes may monitor network traffic within a computer network, and dynamically identify one or more paths within the network that specifically require performance monitoring based on one or more traffic criteria triggered by the monitoring. The one or more paths may each include one or more path nodes. The one or more monitoring nodes may then request that the one or more path nodes initiate transmission of performance indicia, which may allow the one or more monitoring nodes to monitor the performance of the one or more paths based on the performance indicia received at the one or more monitoring nodes.

### TECHNICAL FIELD

The present disclosure relates generally to computer networks and, more particularly, to monitoring Quality of Service (QoS) within constrained computer networks.

### BACKGROUND

Constrained networks such as, for example, Low power and Lossy Networks (LLNs), e.g., sensor networks, have a myriad of applications, such as Smart Grid, Smart Cities, home and building automation, etc. Various challenges are presented with LLNs, such as lossy links, low bandwidth, battery operation, low memory and/or processing capability, etc. Large-scale IP smart object networks pose a number of technical challenges. For instance, the degree of density of such networks (such as Smart Grid networks with a large number of sensors and actuators, smart cities, or advanced metering infrastructure or “AMI” networks) may be extremely high: it is not rare for each node to see several hundreds of neighbors. This is particularly problematic for LLNs, where constrained links can wreak havoc on data transmission.

Applying quality of service (QoS) techniques are thus generally desired in order to maintain data transmission reliability and control delays in LLNs. However, since the devices themselves are also constrained, the complexity of QoS in such networks can be problematic. That is, a primary challenge lies in the overall complexity of QoS architectures in LLNs. For instance, in conventional networks, policies must be specified for packet coloring, congestion avoidance algorithms must be configured on nodes, in addition to queuing disciplines. These algorithms all generally require a deep knowledge of the traffic pattern, link-layer characteristics, node resources, etc., and comprise a number of parameters to configure on each individual device to effectively provide adequate network-wide QoS.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example packet format;

FIG. 4 illustrates an example directed acyclic graph (DAG) in the computer network of FIG. 1;

FIGS. 5A-5C illustrate an example of QoS monitoring within a constrained network;

FIG. 6 illustrates an example of QoS monitoring within a constrained network that lacks a root node; and

FIG. 7 illustrates an example simplified procedure for QoS monitoring within a constrained network.

### DESCRIPTION OF EXAMPLE EMBODIMENTS

### Overview

According to one or more embodiments of the disclosure, one or more monitoring nodes may monitor network traffic within a computer network, and dynamically identify one or more paths or individual nodes within the network that specifically require performance monitoring based on one or more traffic criteria triggered by the monitoring. The one or more paths may each include one or more path nodes. The one or more monitoring nodes may then request that the one or more path nodes, or individual nodes, initiate transmission of performance indicia, which may allow the one or more monitoring nodes to monitor the performance of the one or more paths, or individual nodes, based on the performance indicia received at the one or more monitoring nodes.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routes (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

Notably, mesh networks have become increasingly popular and practical in recent years. In particular, shared-media mesh networks, such as wireless or PLC networks, etc., are often on what is referred to as Low-Power and Lossy Networks (LLNs), which are a class of network in which both the routers and their interconnects are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen or up to thousands or even millions of LLN routers, and support point-to-point traffic (between devices inside the LLN), point-to-multipoint traffic (from a central control point such as the root node to a subset of devices inside the LLN) and multipoint-to-point traffic (from devices inside the LLN towards a central control point).

Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, building and industrial automation, and cars (e.g., that can interconnect millions of objects for sensing things like power quality, tire pressure, and temperature, and that can actuate engines and lights), it has been of the utmost importance to extend the IP protocol suite for these networks.

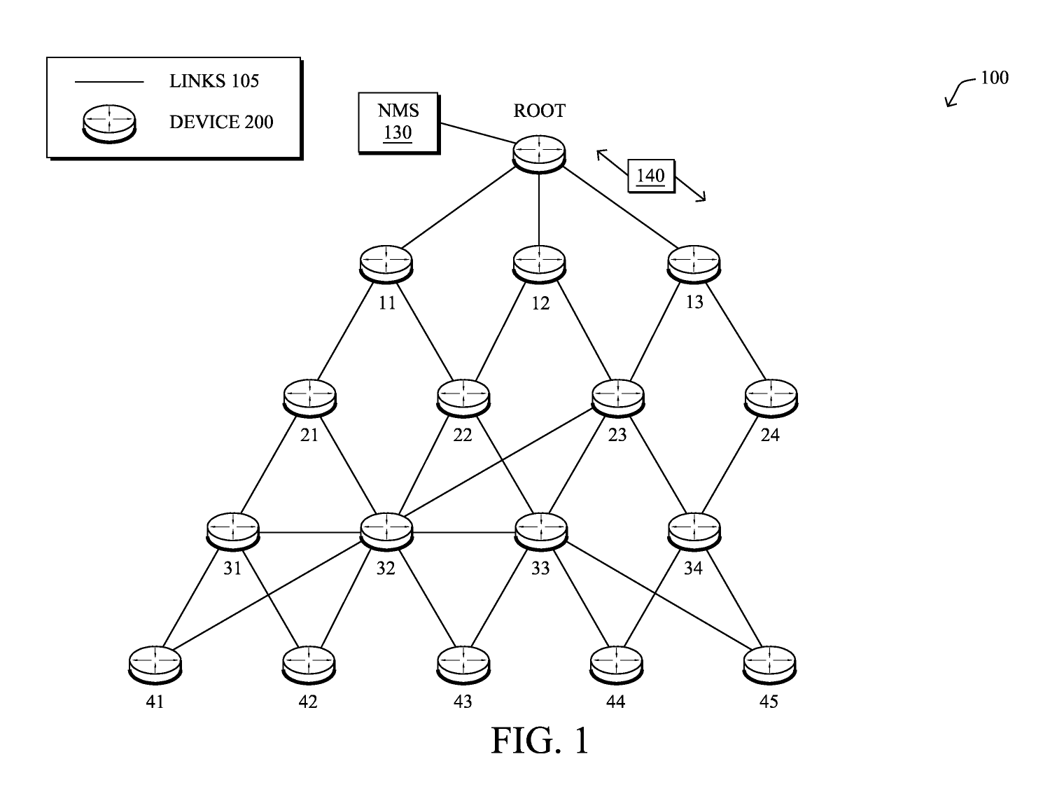

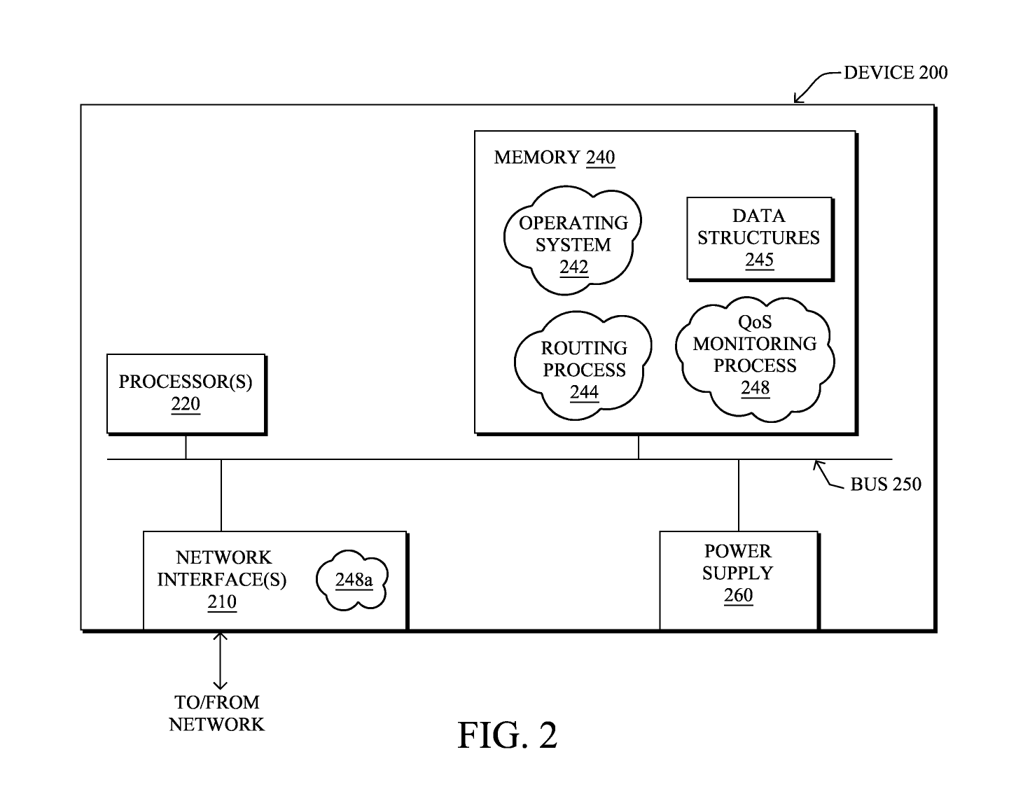

FIG. 1 is a schematic block diagram of an example computer network 100 illustratively comprising nodes/devices 200 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 200, such as, e.g., routers, sensors, computers, etc., may be in communication with other nodes 200, e.g., based on distance, signal strength, current operational status, location, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure. In addition, a network management server (NMS) 130, or other head-end application device located beyond the root device (e.g., via a WAN), may also be in communication with the network 100.

Data packets 140 (e.g., traffic and/or messages sent between the devices/nodes) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244 and an illustrative “QoS monitoring” process 248, as described herein. Note that while QoS monitoring process 248 is shown in centralized memory 240, alternative embodiments provide for the process to be specifically operated within the network interfaces 210, such as a component of a network layer operation within the network interfaces (as process “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. As described above, the term “Internet of Things” or “IoT” may be used by those in the art to refer to uniquely identifiable objects (things) and their virtual representations in a network-based architecture. In particular, the term “IoT” generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications (e.g., smart grid, smart cities, building and industrial automation, etc.), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node that is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by DAG process 246) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF Internet Draft, entitled “Routing Metrics used for Path Calculation in Low Power and Lossy Networks” <draft-ietf-roll-routing-metrics-19> by Vasseur, et al. (Mar. 1, 2011 version). Further, an example OF (e.g., a default OF) may be found in an IETF RFC, entitled “RPL Objective Function 0” <RFC 6552> by Thubert (March 2012 version) and “The Minimum Rank Objective Function with Hysteresis” <RFC 6719> by O. Gnawali et al. (September 2012 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

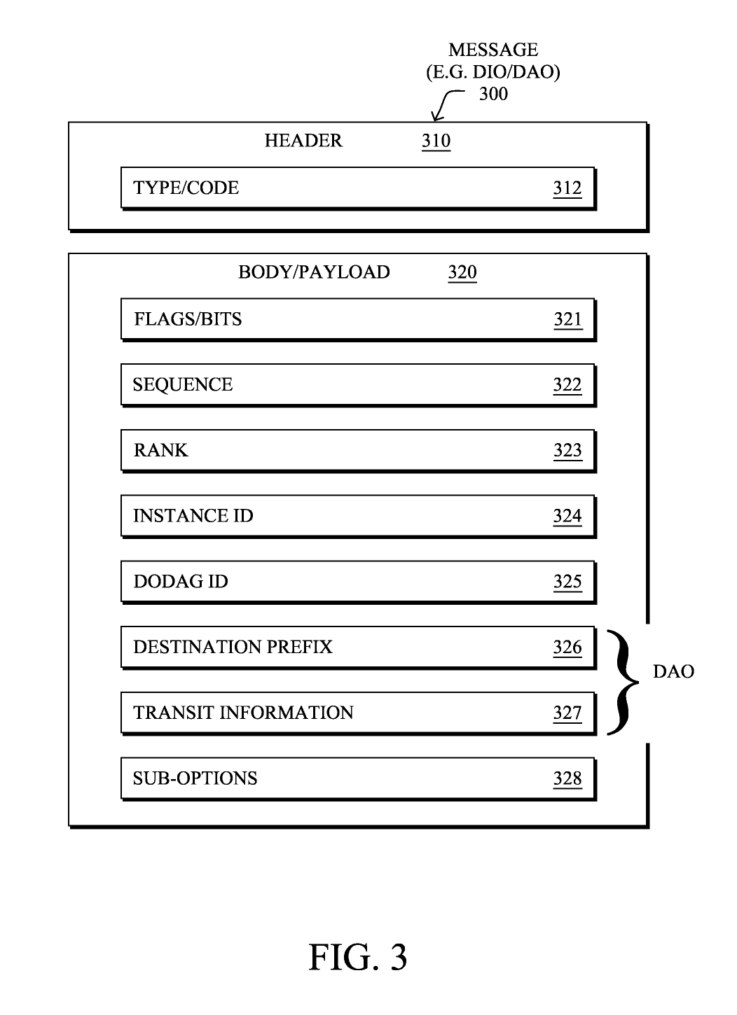

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (e.g., DAO_Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

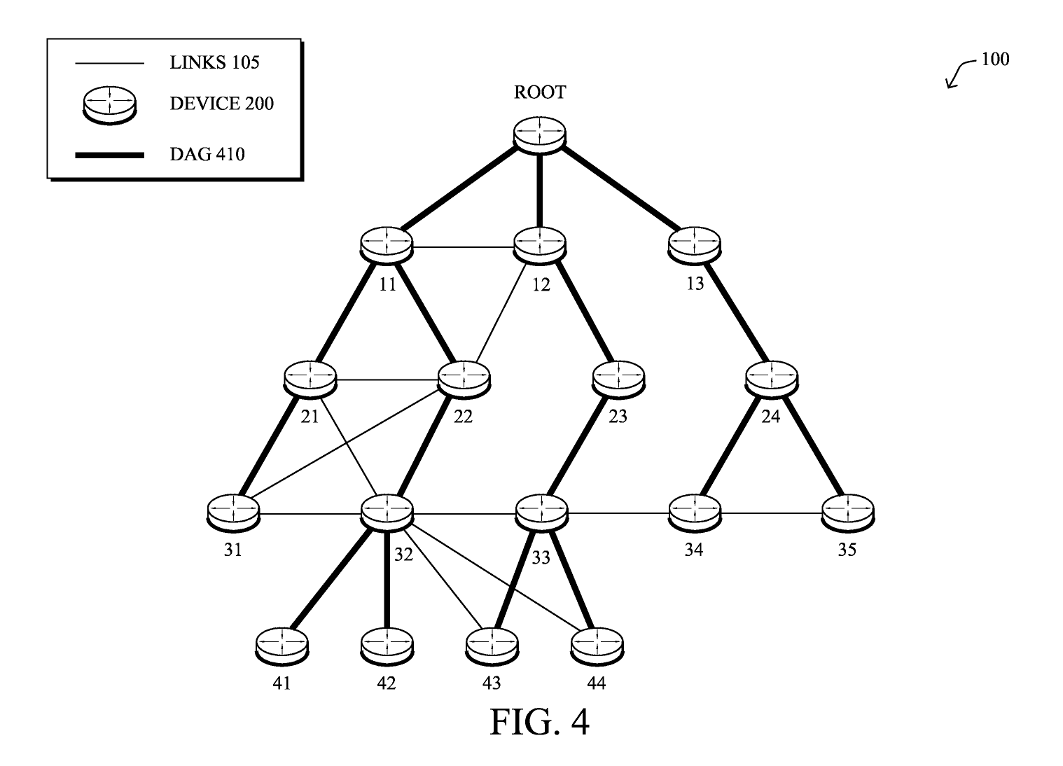

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein. Note that although certain examples described herein relate to DAGs, the embodiments of the disclosure are not so limited, and may be based on any suitable routing topology, particularly for constrained networks.

As noted above, shared-media communication networks, such as wireless and power-line communication (PLC) networks (a type of communication over power-lines), provide an enabling technology for networking communication and can be used for example in Advanced Metering Infrastructure (AMI) networks, and are also useful within homes and buildings. Interestingly, PLC lines share many characteristics with low power radio (wireless) technologies. In particular, though each device in a given PLC network may be connected to the same physical power-line, due to their noisy environment, a PLC link is very much a multi-hop link, and connectivity is highly unpredictable, thus requiring multi-hop routing when the signal is too weak. For instance, the far-reaching physical media exhibits a harsh noisy environment due to electrical distribution transformers, commercial and residential electric appliances, and cross-talk effects. As an example, even within a building the average number of hops may be between two and three (even larger when having to cross phases), while on an AMI network, on the same power phase line, the number of hops may vary during a day between one and 15-20. Those skilled in the art would thus recognize that due to various reasons, including long power lines, interferences, etc., a PLC connection may traverse multiple hops. In other words, PLC cannot be seen as a “flat wire” equivalent to broadcast media (such as Ethernet), since they are multi-hop networks by essence.

Furthermore, such communication links are usually shared (e.g., by using wireless mesh or PLC networks) and provide a very limited capacity (e.g., from a few Kbits/s to a few dozen KBits/s). LLN link technologies typically communicate over a physical medium that is strongly affected by environmental conditions that change over time. For example, LLN link technologies may include temporal changes in interference (e.g., other wireless networks or electric appliances), spatial/physical obstruction (e.g., doors opening/closing or seasonal changes in foliage density of trees), and/or propagation characteristics of the physical media (e.g., changes in temperature, humidity, etc.). The timescale of such temporal changes may range from milliseconds (e.g., transmissions from other wireless networks) to months (e.g., seasonal changes of outdoor environment). For example, with a PLC link the far-reaching physical media typically exhibits a harsh noisy environment due to a variety of sources including, for example, electrical distribution transformers, commercial and residential electric appliances, and cross-talk effects. Real world testing suggests that PLC link technologies may be subject to high instability. For example, testing suggests that the number of hops required to reach a destination may vary between 1 and 17 hops during the course of a day, with almost no predictability. It has been observed that RF and PLC links are prone to a number of failures, and it is not unusual to see extremely high Bit Error Rates (BER) with packet loss that may be as high as 50-60%, coupled with intermittent connectivity.

As further noted above, many LLNs, particularly AMI networks, demand that many different applications operate over the network. For example, the following list of applications may operate simultaneously over AMI networks:
1) Automated Meter Reading that involves periodically retrieving meter readings from each individual meter to a head-end server;
2) Firmware upgrades, e.g., that involve communicating relatively large firmware images (often 500 KB or more) from a head-end server to one device, multiple devices, or all devices in the network;
3) Retrieving load curves;
4) Real-time alarms generated by meters (e.g., power outage events) that actually act as sensors;
5) Periodically retrieving network management information from each meter to a Network Management System (NMS) 130;
6) Supporting demand response applications by sending multicast messages from a head-end device to large numbers of meters;
7) Etc.
   One of skill in the art will appreciate that the above-enumerated examples are similar for other types of LLNs.

Generally speaking, these different applications have significantly different traffic characteristics, for example, unicast vs. multicast, small units of data vs. large units of data, low-latency vs. latency-tolerant, flows toward a head-end vs. away from the head-end, etc. Furthermore, since these applications must operate simultaneously over a highly constrained LLN network, the network can easily experience congestion, especially when different applications are sending traffic simultaneously. For example, the bandwidth of LLN links may be as low as a few KBits/s, and even lower when crossing transformers (for PLC). Without proper mechanisms, these situations can cause networks to violate critical service level agreements (SLAs), e.g., delaying the reception of critical alarms from a meter. Accordingly, Quality of Service (QoS) mechanisms are a critical functionality in shared-media communication networks, particularly in highly constrained LLNs.

Numerous QoS mechanisms have been developed for “classic” IP networks (unconstrained), including: (1) packet coloring and classification (e.g., by applications or Edge network entry points), (2) congestion avoidance algorithms with random drops for back-pressure on TCP (e.g., WRED, etc.), (3) queuing techniques (e.g., preemptive queuing+round robin+dynamic priorities), (4) bandwidth reservation (e.g., Diffserv (by CoS), Intserv (RSVP(-TE), etc.), (5) Input/Output shaping (e.g., congestion-based traffic shaping), (6) Call Admission Control (CAC) using protocols such as the Resource reSerVation Protocol (RSVP) and/or input traffic shapers, (7) Traffic Engineering, (8) Congestion Avoidance techniques, etc. However, while some of these techniques may apply to LLNs, most are not suitable because they are too costly in terms of bandwidth (control plane overhead), memory (state maintenance), and/or CPU processing. Indeed, policies must be specified for packet coloring, and queuing techniques and congestion avoidance algorithms such as WRED must be configured on nodes. Such algorithms require a deep knowledge of traffic patterns, link layer characteristics, and node resources with respect to a number of parameters in order to configure each individual device.

QoS Monitoring in Constrained Networks

According to the techniques described herein, a capable node (e.g., a LBR/Root, FAR, etc.), or nodes, within a constrained network (e.g., a LLN) may monitor network traffic and dynamically and proactively identify paths and/or individual nodes that require QoS monitoring to, for example, maintain compliance with a SLA. For instance, the capable node, or nodes, may monitor and correlate sets of events, traffic flow patterns, traffic volume, etc., observed in the network to identify paths or individual nodes within the network that may require specific QoS monitoring (e.g., paths/nodes with heavy traffic, critical traffic, etc.), and differentiate these traffic routes from those that are non-critical. Once such paths or individual nodes within the network are identified, the capable node(s) may generate compressed requests (e.g., by using Bloom filters) that trigger nodes within the identified paths to time-stamp their network traffic, generate time-stamped probes, and/or propagate other indicia that may be used as QoS monitoring metrics, optionally according to a time schedule. The set of QoS monitoring metrics, some directly observed, such as path delays (automatically computed), and/or indirectly inferred, such as DAG impact. The QoS monitoring metrics may then be provided to the routing engine for routing topology changes.

Specifically, according to one or more embodiments of the disclosure as described in detail below, one or more monitoring nodes may monitor network traffic within a computer network, and dynamically identify one or more paths and/or individual nodes within the network that specifically require performance monitoring based on one or more traffic criteria triggered by the monitoring. The one or more paths may each include one or more path nodes. The one or more monitoring nodes may then request that the one or more path nodes and/or individual nodes initiate transmission of performance indicia, which may allow the one or more monitoring nodes to monitor the performance of the one or more paths and/or individual nodes based on the performance indicia received at the one or more monitoring nodes.

Illustratively, the techniques described herein may be performed by hardware, software, and/or firmware, such as in accordance with the “QoS monitoring” process 248/248a shown in FIG. 2, which may contain computer executable instructions executed by the processor 220 (or independent processor of interfaces 210) to perform functions relating to the techniques described herein, e.g., in conjunction with routing process 244. For example, the techniques herein may be treated as extensions to conventional protocols, such as the various PLC protocols or wireless communication protocols, and as such, may be processed by similar components understood in the art that execute those protocols.

Operationally, the techniques herein generally relate to identifying specific paths/routes/individual nodes within a constrained network that are transmitting heavy/critical traffic, and specifically applying QoS monitoring to the identified paths or individual nodes to ensure that the heavy/critical traffic flows meet the requirements of a SLA. According to the techniques herein, a capable node (e.g., a LBR/Root) within a constrained network (e.g., a LLN) may identify and classify traffic between two exemplary nodes “A” and “B” as critical traffic (e.g., Distributed Automation traffic, network fault conditions, etc.), heavy traffic (e.g., more than “X” packets/second), or non-critical (e.g., meter readings, etc.). For example, the capable node may use deep packet inspection (DPI) techniques to identify and classify particular network traffic as traffic that is critical, heavy, etc.

Network traffic may be classified as “critical” or “heavy” based on a variety of criteria. For example, critical traffic may be classified based on pre-configured static rules, or rules that are dynamically generated based on a learning profile/type. Additionally, a capable node may also deem a traffic flow to/from a node/device to be critical by detecting a set of events in the network. For example, the capable node (e.g., a LBR, FAR, etc.) may detect a network event, or set of network events, associated with a particular node (e.g., a node sending an alarm indicative of an error condition in the network), and begin QoS monitoring for the packets sent along the path from the LBR and the node to assess whether the path traffic meets the SLA requirements (as described below). Network traffic may be identified as “heavy” based on the presence of a network node that, for example, generates/receives more than X packets/second.

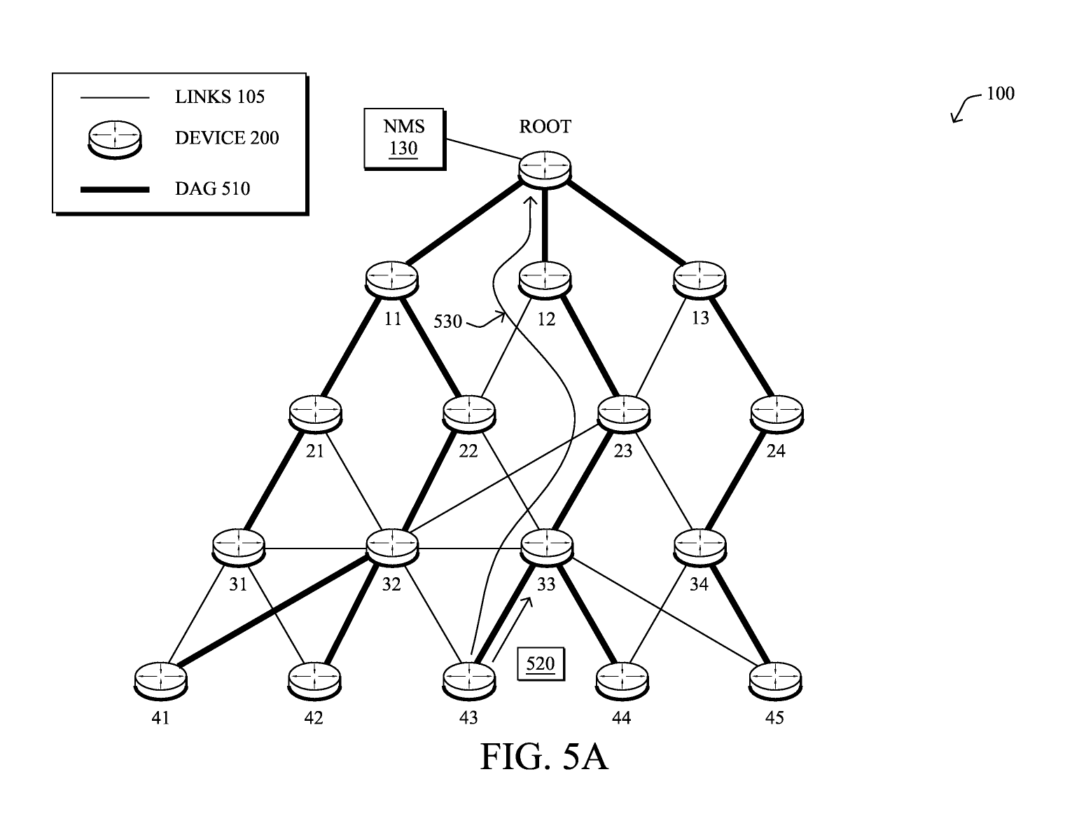

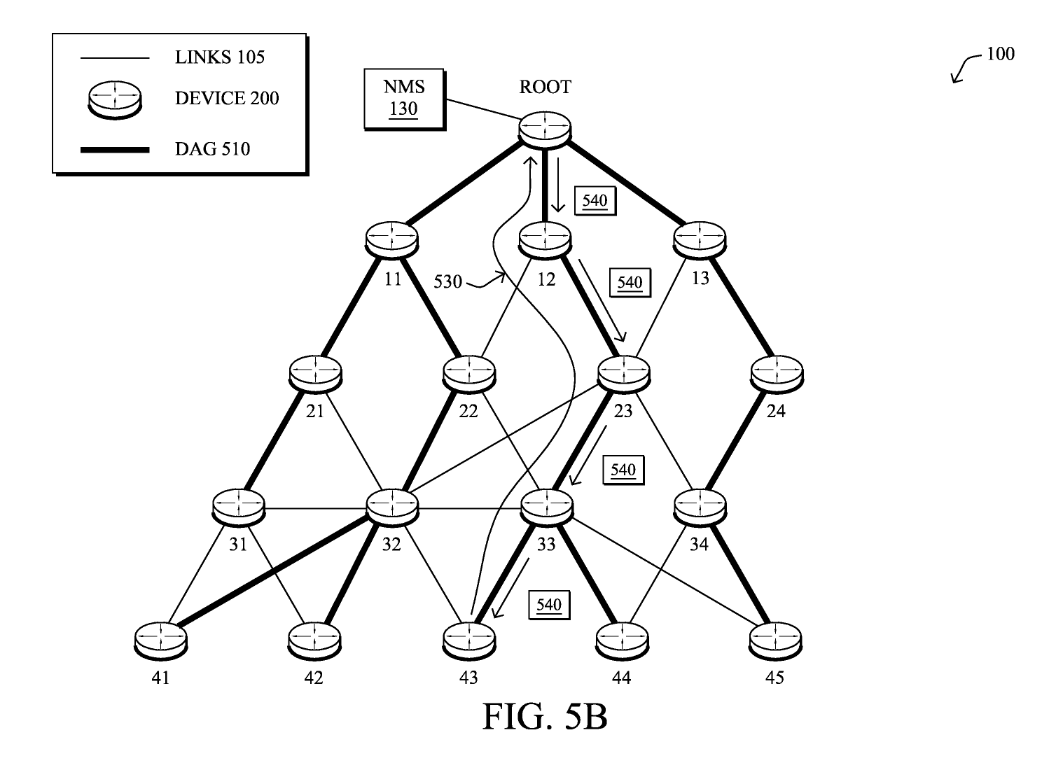

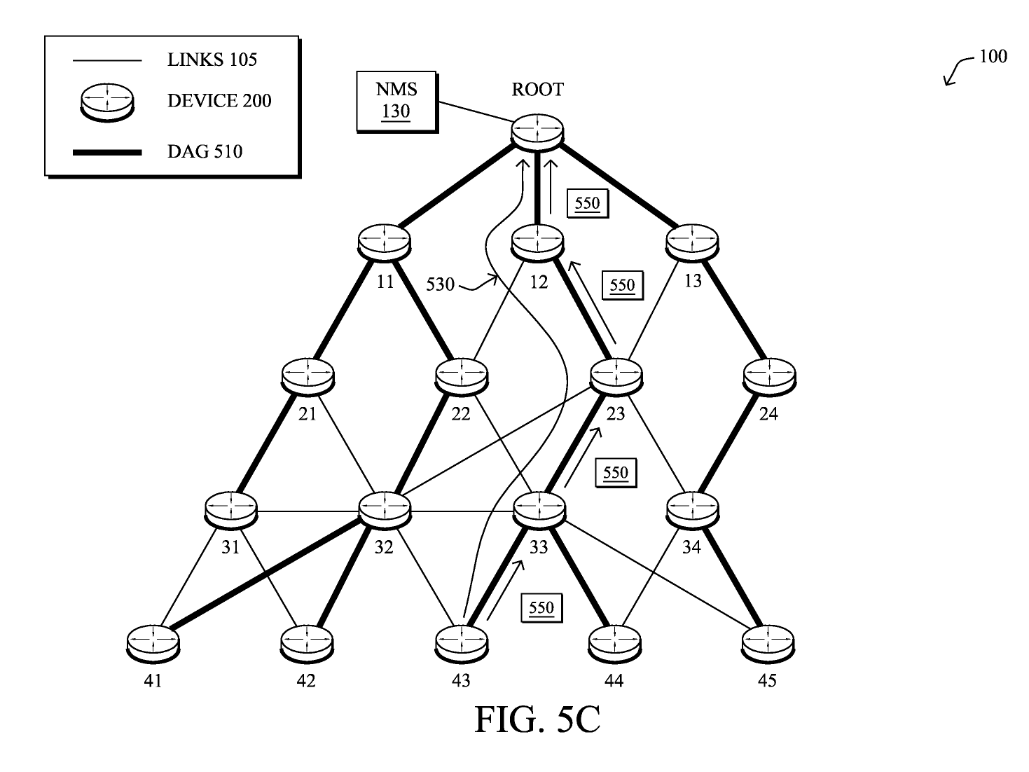

FIG. 5A illustrates an example of the identification and classification of “critical” network traffic within a network 100 comprising DAG 510. A capable node (e.g., the Root) may detect (e.g., by using DPI techniques) that node 43 is transmitting alarm packets 520 that indicate an alarm condition within network 100. The Root may then identify and classify path 530 within DAG 510 as carrying “critical” network traffic. The output of the Root node's identification and classification process may be one or more critical nodes (e.g., a set of critical nodes) within the network 100 that require QoS monitoring (e.g., nodes <43, 33, 23, 12> within critical path 530, or more generally nodes <N1, N2, N3, . . . Nk>).

According to the techniques herein, classification information pertaining to the one or more critical nodes may be maintained on the Root/LBR, which may determine on a periodic basis the probability that a node within network 100 may be a source, destination, or transit hop for such network traffic identified and classified as “critical” (e.g., nodes within route 420) by the classification process of the Root/LBR. Based on this information, the Root/LBR may proactively monitor the QoS for the one or more critical nodes identified and classified as critical nodes. In other words, the Root may proactively apply QoS monitoring within the constrained network 100 to a set of critical nodes that exceed a pre-defined threshold of having a higher probability of being required for the transmission of critical or heavy network traffic.

In one or more embodiments, the Root/LBR may then illustratively use a compression technique such as Bloom filters to record the path of one or more critical nodes identified above (e.g., nodes <43, 33, 23, 12>). For example, according to the techniques herein, the Root/LBR may incorporate Bloom filters comprising the one or more critical nodes into messages (e.g., routing control plane messages, multicast messages, broadcast messages, unicast messages, etc.) used to build the routing topology of network 100. One of skill in the art will appreciate that such Bloom filters may be incorporated into a variety of routing control plane protocols. For example, in the case of a proactive protocol such as RPL, the Bloom filters may be carried in the DODAG container within the DIO message. In the case of a reactive protocol such as Load-ng or AODV, the Bloom filter may be carried within a RREQ message used to find the path to the location to the destination.

The use of Bloom filters allows encoding of the one or more critical nodes, or set of critical nodes, in a manner that minimizes the number of bits required, and eliminates the need to record IPv6 addresses for all of the nodes in the set of critical nodes. Additionally, piggybacking the QoS recording request within a message (e.g., a routing control plane message, multicast message, etc.) that uses a Bloom filter to list the one or more critical nodes, or set of nodes (e.g., nodes <N1, N2, N3, . . . Nk>), significantly reduces the associated control plane overhead.

Illustratively, as shown in FIG. 5B, the Root/LBR may send routing control plane messages 540 comprising Bloom filters that have recorded the one or more critical nodes to the critical node 43 of critical path (or route) 530. Routing control plane message 540 may trigger at least one node of the one or more critical nodes within critical path 530 (e.g., 43, 33, 23, 12) to transmit one or more QoS monitoring metrics that may be used for specific QoS monitoring of critical paths 530 to ensure that the relevant SLA requirements are fulfilled.

As illustrated in FIG. 5C, routing control plane messages 540 may include a request that critical nodes within critical path 530 (e.g., nodes 43, 33, 23, and/or 12) generate QoS monitoring metric packets 550, which may comprise indicia such as jittering, time-stamping, etc., that enable the Root/LBR to conduct QoS monitoring of critical path 530. If such a critical node is currently inactive, it may initiate de novo packet transmission comprising the requested QoS monitoring metric(s) in response to routing control plane messages 540. However, if the critical node is already forwarding packets, it need not inject any additional packet traffic into the network; rather, in one illustrative embodiment, the critical node may effectively convert the forwarded packets into QoS monitoring metric packets 550 by adding an additional IPv6 hop-by-hop header to jitter and/or timestamp the forwarded packets, which may then be subject to QoS monitoring as described further below. In addition, the Root/LBR may also obtain QoS monitoring metrics by using time-stamped routing control plane messages 540 as probes. For example, a RPL-node may start time-stamping DAO messages sent to the FAR for some specific period of time.

While FIG. 5C illustrates the transmission of QoS monitoring metric packets 550 in response to routing control plane messages 540, it is also contemplated within the scope of the disclosure that the Root/LBR may request initiation of QoS monitoring metric packets 550 from one or more critical nodes in network 100 by a message other than a routing control plane message (e.g., a QoS metric request message).

In another embodiment, the routing control plane messages 540 sent by the Root/LBR may further comprise information regarding how many and/or when QoS monitoring metric packets 550 should be transmitted by the one or more critical nodes in the network to the Root/LBR, and/or over what period of time such packets should be transmitted (e.g., a time schedule). By limiting the number of QoS monitoring metric packets 550 that are transmitted and/or the time interval over which they are transmitted, the control plane cost of implementing QoS monitoring for specific routes may also be minimized. It is contemplated within the scope of the disclosure that such number/time interval parameters may be dynamically determined according to the observed packet flow profiles detecting during network monitoring by the Root to identify and/or classify critical/heavy network traffic.

When the Root/LBR receives QoS monitoring metric packets 550 from the one or more critical nodes within critical path 530, the Root/LBR may compute the QoS metric of interest and provide the resulting QoS data for the QoS monitored path to the NMS (or other network management agent). In other words, in one embodiment, the paths may be identified, classified, and monitored from within the network, rather than by the NMS. One of skill in the art will appreciate that the Root may process different QoS metrics in different ways. For example, some QoS metrics, such as delay, may be inferred from timestamps included in QoS monitoring metric packets 550. Other QoS metrics, such as hop count, link states, etc., may be directly obtained from the received message (e.g., routing control plane messages 540, CoAP messages, etc.). Still other QoS metrics (e.g., network hotspots, time variation rates, etc.) may be computed using either simple statistical analysis (to keep computational overhead low) or a machine learning engine. Together, these QoS metrics may be used to represent complex network characteristics such as, for example, path characteristics, node characteristics, DAG characteristics, etc. Additionally, QoS metrics may also represent many attributes of the network topology or its subset. Optionally, this information may be provided to the routing engine to be translated into routing topology tuning.

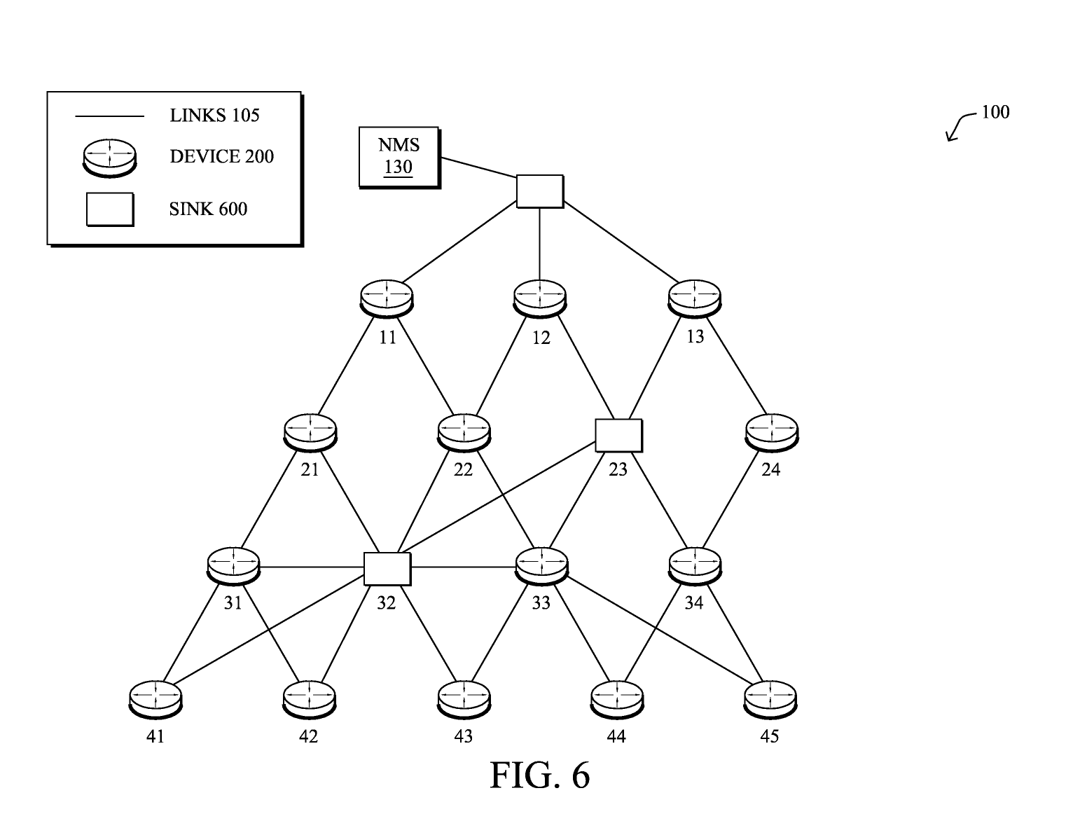

Although the above-described QoS monitoring techniques have been illustrated with respect to an LLN in which all network traffic transits through the Root/LBR, it should be noted that the techniques described herein may be generally applied to any network, particularly to any constrained network. For example, as shown in FIG. 6, a network 100 that does not have a central node through which all traffic is piped (e.g., like the LBR of an LLN), may have one or more sinks 600 that reside at strategic locations throughout the network (e.g., nodes 32, 23, 1) to ensure that all potential critical traffic within the network may be monitored according to the techniques described herein. In such an environment, the sinks may operate independently or in collaboration (e.g., with each other or with an NMS) to perform the QoS monitoring techniques described above.

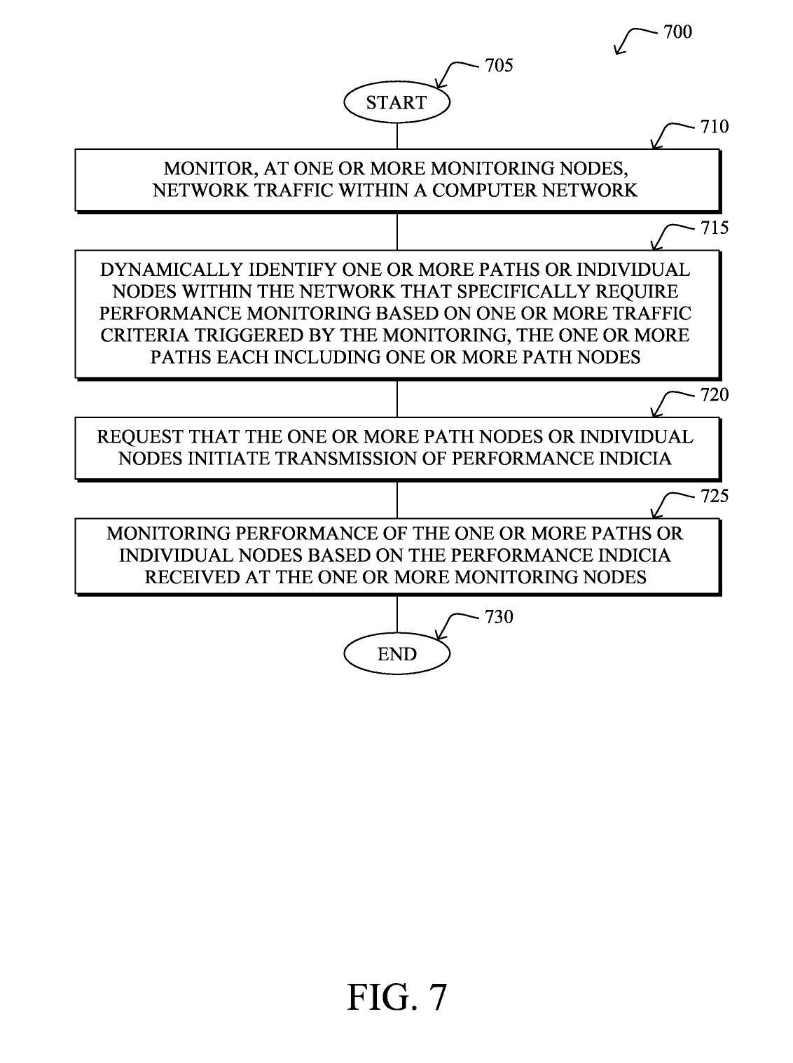

FIG. 7 illustrates an example simplified procedure 700 for QoS monitoring in a constrained network in accordance with one or more embodiments described herein. The procedure 700 may start at step 705, and continues to step 710, where, as described in greater detail above, one or more monitoring nodes may monitor network traffic within a computer network. As shown in step 715, the one or more monitoring nodes may dynamically identify one or more paths or individual nodes within the network that specifically require performance monitoring based on one or more traffic criteria triggered by the monitoring, and the one or more paths may each include one or more path nodes. The one or more monitoring nodes may then request that the one or more path nodes or individual nodes initiate transmission of performance indicia, as shown in step 720, which may allow the one or more monitoring nodes to monitor the performance of the one or more paths or individual nodes based on the performance indicia received at the one or more monitoring nodes as indicated in step 725. The procedure 700 illustratively ends in step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide traffic-based quality of service (QoS) monitoring in highly constrained networks. In particular, the techniques herein provide the ability to proactively and dynamically apply QoS monitoring to specific critical routes within a constrained network from within the network itself. In other words, the NMS is not involved. In contrast to “classic” computer networks, in which QoS is typically monitored by using overhead intensive techniques such as probes and/or heavy protocols to retrieve detailed network statistics, the techniques described herein may provide QoS monitoring of specific routes within a constrained network without significantly increasing control plane overhead.

While there have been shown and described illustrative embodiments that provide traffic-based quality of service (QoS) monitoring in highly constrained networks, it is to be understood that various other adaptations and modifications may be made within the spirit and scope of the embodiments herein. For example, the embodiments have been shown and described herein with relation to LLNs. However, the embodiments in their broader sense are not as limited, and may, in fact, be used with other types of networks and/or protocols. In addition, while certain protocols are shown, such as RPL, other suitable protocols may be used, accordingly. Also, while the techniques generally describe QoS monitoring by a Root/LBR, other capable nodes such as, for example, a NMS or sink, may also be used.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
monitoring, at one or more monitoring nodes, network traffic within a computer network;
dynamically identifying one or more paths or individual nodes within the network that specifically require performance monitoring based on one or more traffic criteria triggered by the monitoring, the one or more paths each including one or more path nodes;
requesting that the one or more path nodes or individual nodes initiate transmission of performance indicia; and
monitoring performance of the one or more paths or individual nodes based on the performance indicia received at the one or more monitoring nodes.

2. The method as in claim 1, further comprising:
classifying the dynamically identified one or more paths or individual nodes as necessary for critical or heavy network traffic.

3. The method as in claim 1, further comprising:
comparing the performance of the one or more paths or individual nodes to a service level agreement (SLA) to ensure that the SLA is fulfilled.

4. The method as in claim 1, wherein requesting further comprises:
sending a message to the one or more path nodes or individual nodes, the message including a bloom filter to compress the one or more path nodes or individual nodes into a node list, wherein the message is selected from the group consisting of a routing control plane message, a broadcast message, a multicast message, and a unicast message.

5. The method as in claim 1, wherein the one or more monitoring nodes are a low power and lossy network border router (LBR) or a network sink.

6. The method as in claim 1, wherein information pertaining to the one or more identified path nodes or individual nodes is maintained on the one or more monitoring nodes.

7. The method as in claim 1, wherein the performance indicia are selected from the group consisting of: jittering, time stamping, delay, received signal strength indication, CPU, battery level, queue length, and any combination thereof.

8. The method as in claim 7, wherein admission state is a metric used by nodes when determining which LLN to join.

9. The method as in claim 1, wherein requesting further comprises:
specifying that the performance indicia be transmitted according to one or more transmission criteria selected from the group consisting of a particular number of transmission packets, a particular transmission time, a particular transmission time interval, and piggybacking the performance indicia on existing user traffic.

10. The method as in claim 3, further comprising:
preparing a QoS report; and
forwarding the QoS report to the network management agent.

11. An apparatus, comprising:
one or more network interfaces to communicate with a low power and lossy network (LLN);
a processor coupled to the network interfaces and adapted to execute one or more processes; and
a memory configured to store a process executable by the processor, the process when executed operable to:
monitor network traffic within a computer network;
dynamically identify one or more paths or individual nodes within the network that specifically require performance monitoring based on one or more traffic criteria triggered by the monitoring, the one or more paths each including one or more path nodes;
request that the one or more path nodes or individual nodes initiate transmission of performance indicia; and
is monitor performance of the one or more paths or individual nodes based on the performance indicia received at the one or more monitoring nodes.

12. The apparatus as in claim 11, wherein the process when executed is further operable to:
classify the dynamically identified one or more paths or individual nodes as necessary for critical and/or heavy network traffic.

13. The apparatus as in claim 11, wherein the process when executed is further operable to:
compare the performance of the one or more paths or individual nodes to a service level agreement (SLA) to ensure that the SLA is fulfilled.

14. The apparatus as in claim 11, wherein the process when executed is further operable to:
send a message to the one or more path nodes, the message including a bloom filter, wherein the message is selected from the group consisting of a routing control plane message, a broadcast message, a multicast message, and a unicast message.

15. The apparatus as in claim 11, wherein the process when executed is further operable to:
send a routing control plane message to the one or more path nodes or individual nodes, the routing control plane message including a bloom filter.

16. The apparatus as in claim 11, wherein the one or more monitoring nodes are a low power and lossy network border router (LBR) or a network sink.

17. The apparatus as in claim 11, wherein information pertaining to the one or more identified path nodes or individual nodes is maintained on the one or more monitoring nodes.

18. The apparatus as in claim 11, wherein the performance indicia are selected from the group consisting of: jittering, time stamping, delay, received signal strength indication, CPU, battery level, queue length, and any combination thereof.

19. The apparatus as in claim 11, wherein admission state is a metric used by nodes when determining which LLN to join.

20. A tangible, non-transitory, computer-readable media having software encoded thereon, the software when executed by a processor operable to:
monitor network traffic within a computer network;
dynamically identify one or more paths or individual nodes within the network that specifically require performance monitoring based on one or more traffic criteria triggered by the monitoring, the one or more paths each including one or more path nodes;
request that the one or more path nodes or individual nodes initiate transmission of performance indicia; and
monitor performance of the one or more paths or individual nodes based on the performance indicia received at the one or more monitoring nodes.

21. The computer-readable media as in claim 20, wherein the software when executed is further operable to:
classify the dynamically identified one or more paths or individual nodes as necessary for critical and/or heavy network traffic.

22. The computer-readable media as in claim 20, wherein the software when executed is further operable to:
compare the performance of the one or more paths or individual nodes to a service level agreement (SLA) to ensure that the SLA is fulfilled.

23. The computer-readable media as in claim 20, wherein the software when executed is further operable to:
send a message to the one or more path nodes or individual nodes, the message including a bloom filter, wherein the message is selected from the group consisting of a routing control plane message, a broadcast message, a multicast message, and a unicast message.
